(19) United States
(12) Patent Application Publication
(10) Pub. No.: US 2011/0146156 A1
(43) Pub. Date: Jun. 23, 2011

(54) METHOD FOR PRODUCING A FUEL BY GASIFICATION IN A HIGH-TEMPERATURE GASIFIER

(75) Inventors: Mikko KARA, Veikkola (FI); Mika TIMONEN, Jyvaskyla (FI)

(73) Assignee: VAPO OY, Jyvaskyla (FI)

(21) Appl. No.: 12/962,182

(22) Filed: Dec. 7, 2010

(30) Foreign Application Priority Data
Dec. 18, 2009 (FI) 20096362

(51) Int. Cl. C01B 3/32

(52) U.S. Cl. 48/209; 48/197 R

(57) ABSTRACT

A method is disclosed for producing a fuel by gasification in a high-temperature gasifier such as a dust gasifier. An essential feature of the invention is that in the method the dust gasifier is operated by way of co-feeding along with peat dust another kind of biomass dust such as ground wood-based biomass, soil biomass and/or some other similar biomass.

The invention relates to a method in accordance with the preamble of claim 1 for producing a fuel by gasification in a high-temperature gasifier such as a dust gasifier. The invention also relates to the use of the fuel in accordance with claim 7.

In the art of biomass gasification are known both low- and high-temperature techniques wherein the operation takes place respectively either below or above the melting point of fuel ash. Low-temperature gasifiers operate typically at a maximum temperature of 1000° C. thereby being implemented either as solid-bed reactors (capacity less than 20 MW) or using fluidized-bed technology (capacity greater than 20 MW). The reactors can process fuel of very high moisture content whose particle size is not a critical factor. In a plant equipped with this type of gasifier, the fuel preprocessing stage comprises lump classification (crushing of hard aggregates), removal of rocks and ice, possibly complemented with drying.

In the gasification of biomass and wood in particular, a substantial amount of tar compounds are included in the raw gas when gasification takes place at low temperature of less than 1000° C., for instance. The tar compounds of the gas tend to condensate in the process equipment downstream of the gasifier and cause serious problems in runnability, even within a few minutes after the start of the gasifier operation. The tar compounds of the producer gas do not cause problems if the gas is used in a boiler immediately downstream of the gasifier. Hereby it is necessary to have the gas piping thermally insulated along its entire length or, when necessary, heated to avoid condensation on cold surfaces.

To eliminate problems arising from tar compounds in the postprocessing stages of the gas, e.g., in a syngas-producing Biomass-to-Liquids (BtL) plant, the compounds must either be reformed immediately after the gasifier meaning that the operation takes place in a low-temperature gasification process or, alternatively, gasification must be carried out at a sufficiently high temperature, whereby the tar components decompose already during gasification which process is known as high-temperature gasification.

Reforming of gas containing tar compounds has been investigated by different organizations during the last years, but so far no completely engineered, commercially available or technically viable solutions have been presented.

The CtL (Coal to Liquid) process has been commercially implemented as the entrained flow gasifier, in Finnish generally known as “polykaasutin” (dust gasifier). In this kind of gasifier, coal is milled to dust upstream of the gasifier and is thereupon conveyed with the help of an inert carrier gas to the reactor. This arrangement requires the fuel has been comminuted to a small particle size in the order of 100 μm and exhibits suitable fluidization properties. The dust will fluidize well when it is sufficiently dry, its milled particles are maximally round and the dust does not clump to form agglomerates.

In fluidization, the dust-gas mixture is forced to behave as a fluid. When a gas is injected from below to an easily fluidizable dust layer, the gas is distributed homogeneously in the entire dust bed and the bed starts to “float”, whereby its volume increases. In a weakly fluidizable fuel, the gas blown from below begins to form bubbles or channels in the bed. The bed volume fails to expand and fuel infeed to the reactor becomes difficult or even impossible. One precondition for obtaining fluidizable dust is that its particles are maximally round. The dust material must be sufficiently dry, too.

When implemented in accordance with the prior art, a dust gasifier is a high-temperature gasifier that is reliable in operation, uncomplicated and cost-effective as an investment. However, a drawback hampering a wider use of this equipment has arisen from the fuel combusted therein that, as described above, requires specific conditions for its uncomplicated operation. Hence, it is particularly important to investigate the biofuel to be gasified and its controlled feed to the gasifier.

In the gasification process of biomass, it has been found that peat can be milled in the same fashion as coal into really round particles, yet keeping the required milling energy at a reasonable level. Milling can be performed using either a hammer mill or a ball mill. The coarse fractions leaving the mill can be separated by means of, e.g., an air classifier, and recycled to the mill for further comminution. The required specific milling energy is typically in the order of 20 kWh/t peat.

In contrast, comminution of wood is appreciably more difficult. Owing to the cellulosic fiber structure of wood, grinding primarily produces fibers. In certain types of grinders, the ends of fiber tend to form whiskers whereby the fiber readily begins to clump into agglomerates that further complicate the fluidization of dust. Grinding wood into more spherical particles has been attempted through a process called torrefaction. The torrefaction process as such is well known in the art; more specifically torrefaction accomplishes heating wood chips at a mildly elevated temperature under oxygen-free conditions, whereby cellulose fibers are broken (depolymerized) and the hemicellulosic components that bind the fibers to each other decompose at least partially. Resultingly, the fibers are weakened at certain points at which the fibers are broken during grinding. In tests performed so far it has been found that under favorable conditions torrefied wood can be ground into fluidizable dust. Additionally, as described in publication EP 2009353, specific grinding energy is reduced substantially with regard to grinding of dried wood.

Utilization of torrefaction is yet chiefly under investigation and thus does not represent commercial technology. Moreover, it produces pyrolysis gases and complicates the process. Hence, a torrefaction process connected to a gasifier is similar to a connection of a low-temperature gasifier to a high-temperature gasifier in the fashion known, e.g., from the Carbo-V process developed by Choren Industries. In other words, torrefaction is equivalent to partial charring of wood.

The embodiment according to the present invention now aims to achieve a novel kind of method capable of overcoming the problems discussed above. Laboratory tests have proven that dried peat dust can be fed to a dust gasifier without problems. However, peat cannot be converted cost-efficiently to liquid biofuel, because peat is not categorized as a biofuel in the European Union countries. In contrast, a liquid fuel produced from peat is listed as synthetic. Resultingly, if the biostatus of synthetic liquid fuel derived from peat is desired to be upgraded, a portion of peat feedstock must be replaced by biofuel raw materials listed in EU regulations.

More specifically, the invention is characterized by what is stated in the appended claims. The essential feature of the invention is to implement the novel method by way of co-feeding along with peat dust to a pressurized dust gasifier another kind of biomass dust such as ground wood-based biomass, soil biomass and/or some other similar biomass.

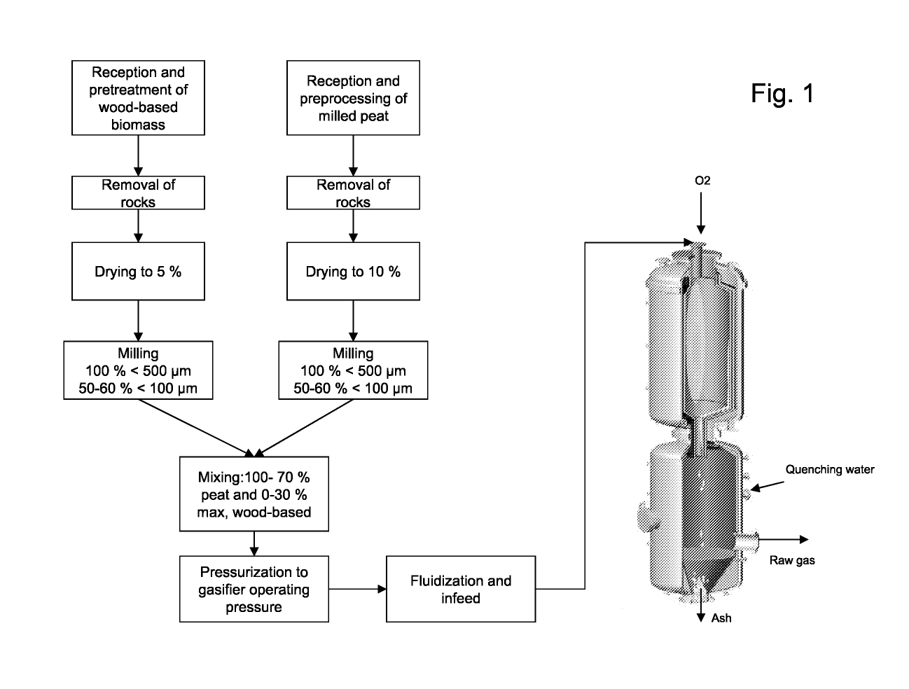

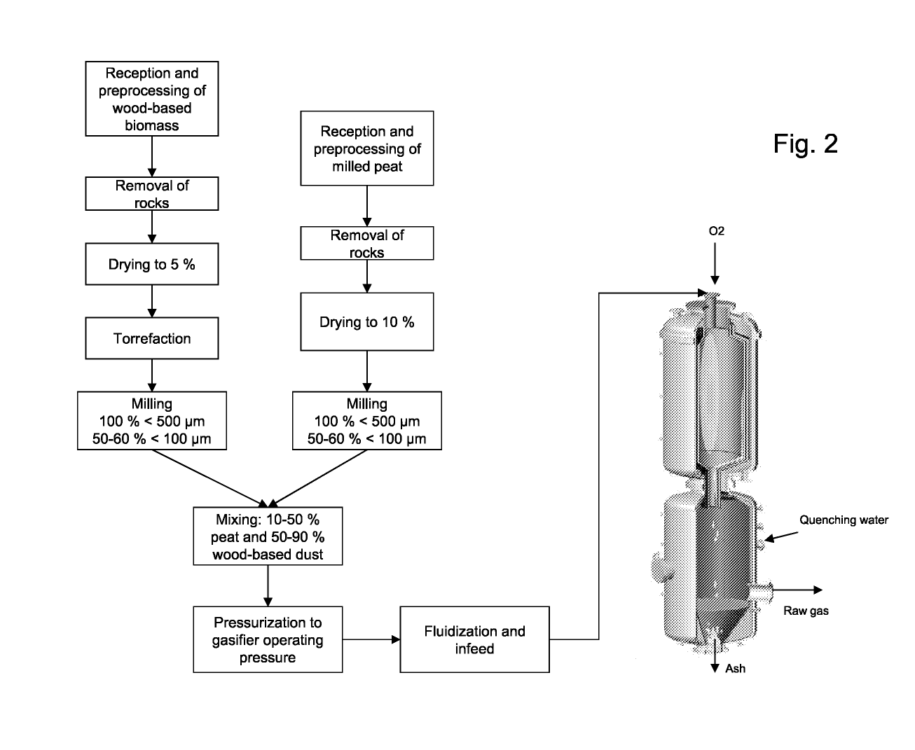

FIGS. 1 and 2 show a process diagram of an embodiment implementing the method.

The invention is directed to a method elucidated in FIGS. 1 and 2 wherein the above-described fibrous, dry wood dust is mixed with peat dust without any essential degradation of its fluidization and transport qualities. In accordance with the invention, a hammer mill was used to comminute wood residuals and bark into a dust classifiable through a mesh with openings of about 100 μm for mixing with peat by a mass fraction of about 0-30%. A mass fraction as high as 20° A) resulted in a well-fluidizable dust. Respectively, if torrefied wood is used in the method, the fraction of wood-based raw material as complementary feedstock along with peat can be increased as high as 50-90%. Fluidization of the mixture can be further improved with prior-art techniques using an agitator, i.e., mixing the dust bed mechanically.

The process shown in FIGS. 1 and 2 have separate reception and pre-processing stages for wood-based biomass and peat. According to the invention, wood chips are dried to a moisture content of about 5% and peat to about 10%. Next, chips and peat are milled to a particle size smaller than 500 μm, whereby at least 50% of the particles are smaller than 100 μm. Chips are milled in one or more stages. The best milling results have been obtained using a cutting mill such as a hammer mill. The mill must be equipped with a classifier serving to recycle the coarse fraction back to the mill. The specified energy consumption herein is typically in the order of 100-200 kWh/t. Peat can be milled in a classifying hammer mill or in a ball mill. Typical specific energy consumption in a ball mill is in the order of 20 kWh/t. Downstream of the milling stage, the peat dust obtained therefrom is mixed with milled wood dust. Typically, the amount of wood dust mixed with peat dust is 10-30%, whereby the amount of peat dust is 70-90%, respectively. Mixing is carried out prior to the fluidization chamber in a separate mixing apparatus. In the mixing stage it is imperative that the wood dust fraction is blended maximally homogeneously with the peat dust.

In tests carried out according to the invention, it has been found that when the fraction of wood dust exceeds 30%, the fluidization qualities deteriorate significantly and infeed of dust to the reactor cannot be performed reliably, while use of torrefied wood dust allows fluidization of a peat-wood mixture even when the wood dust fraction is as high as 50-90%. As the pyrolysis gas is lost in the fuel synthesis when torrefied wood is used, the yield of liquid fuel from the raw material drops. In this alternative embodiment of the method, torrefaction is carried out after drying of wood, prior to the milling stage.

As described above, the invention is directed to a method for producing a fuel by gasification in a high-temperature gasifier such as a dust gasifier. It is an essential feature of the invention that a dust gasifier is operated along with peat dust with another kind of biomass dust such as ground wood-based biomass, while also soil biomass and/or some other similar biomass suited for gasification can be fed to the gasifier. In this fashion a fraction of peat dust raw material to be used as feedstock in a dust gasifier for producing a synthetic liquid fuel and/or certified biofuel can be replaced with dried and milled biomassa dust such as fibrous harvested wood residuals, chipped forest/logging residuals, bark or the like wood-based raw material, soil biomass, biomass dried and milled from waste sludge or any corresponding mass, either as separate fractions or mixtures thereof.

The invention is also directed to use of peat dust in gasification so that wood-based biomass, soil biomass and/or other biomass is added thereto. Besides wood-based biomass and soil biomass, e.g., different kinds of materials dried and milled from various waste sludges may be used as well. The invention is based on the concept that peat dust, which as such a fully functional feedstock material in a dust gasifier, is complemented with another kind of biomass dust that possibly may degrade the qualities of peat dust, however, yet allowing the use of such a dust mixture without compromising the gasification process itself. The qualities of dust as feedstock to a gasifier are determined by the shape of dust particles, size distribution of dust particles, moisture content and other properties of dust such as cohesive forces between dust particles, electrostatic attraction and other like phenomena. Dust is fed to the reactor with the help of a carrier gas, whereupon dust reacts extremely rapidly with oxygen at a high temperature. The reaction or gasification time is less than 1 s. It is crucial to guarantee constant qualities of the dust in order to keep steady infeed conditions, because unstable infeed causes variations in the oxygen-fuel ratio and results in low quality of the producer gas and difficult control of gasifier operation.

To a person skilled in the art it is obvious that the invention is not limited by the above-described exemplary embodiments, but rather may be varied within the inventive spirit and scope of the appended claims.

1. A method for producing a fuel by gasification in a high-temperature gasifier such as a dust gasifier, characterized in that in the method the dust gasifier is operated by way of co-feeding along with peat dust another kind of biomass dust such as ground wood-based biomass, soil biomass and/or some other similar biomass.

2. The method of claim 1, characterized in that in the method for producing a synthetic liquid fuel and/or certified biofuel a fraction of peat dust raw material to be used as feedstock in a dust gasifier is replaced with dried and milled biomassa dust such as fibrous harvested wood residuals, chipped forest/logging residuals, bark or the like wood-based raw material, soil biomass, biomass dried and milled from waste sludge or any corresponding mass, either as separate fractions or mixtures thereof.

3. The method of claim 1, characterized in that gasification in a pressurized dust gasifier is carried out co-feeding specially dried and milled wood dust along with peat dust suited for gasification due to its advantageous particle shape, size distribution, moisture content and mixture ratio of wood-to-peat dust.

4. The method of claim 1, characterized in that the wood-based biomass to be milled into wood dust is dried to a moisture content of about 5% and the peat dust to about 10%, whereupon the biomass is milled to a dust particle size smaller than 500 μm, whereby at least 50% of the particles are smaller than 100 μm.

5. The method of claim 1, characterized in that the wood-based biomass to be milled into wood dust is milled after drying either as such, whereby mixture ratio in the range of 0-30% wood dust and about 100-70% peat dust, or alternatively after torrefaction, whereby mixture ratio is 50-90% wood dust and 10-50% peat dust.

6. The method of claim 1, characterized in that the wood-based biomass is milled, most advantageously using a cutting grinder, in order to give the dust homogeneous qualities as a well-fluidizing dust.

7. Use of peat dust in gasification by way of complementing the feedstock with wood-based biomass, soil biomass and/or other biomass suited for feedstock in a gasifier.

8. The use according to claim 7 of biomass dust, such as milled wood-based biomass, soil biomass and/or other similar biomass suited for feedstock in a gasifier, along with peat dust as feedstock in a high-temperature gasifier in order to produce a fuel gasified in a dust gasifier.

9. The use according to claim 7 for producing a synthetic liquid fuel and/or certified biofuel in which process a fraction of peat dust raw material to be used as feedstock in a dust gasifier is replaced with dried and milled biomassa dust such as fibrous harvested wood residuals, chipped forest/logging residuals, bark or the like wood-based raw material, soil biomass, biomass dried and milled from waste sludge or any corresponding mass, either as separate fractions or mixtures thereof.

10. The use according to claim 7 of dried wood dust along with peat dust as feedstock in such a fashion that gasification in a pressurized dust gasifier is carried out co-feeding specially dried and milled wood dust along with peat dust suited for gasification due to its advantageous particle shape, size distribution, moisture content and mixture ratio of wood-to-peat dust.

11. The method of claim 2, characterized in that gasification in a pressurized dust gasifier is carried out co-feeding specially dried and milled wood dust along with peat dust suited for gasification due to its advantageous particle shape, size distribution, moisture content and mixture ratio of wood-to-peat dust.

12. The method of claim 2, characterized in that the wood-based biomass to be milled into wood dust is dried to a moisture content of about 5% and the peat dust to about 10%, whereupon the biomass is milled to a dust particle size smaller than 500 μm, whereby at least 50% of the particles are smaller than 100 μm.

13. The method of claim 3, characterized in that the wood-based biomass to be milled into wood dust is dried to a moisture content of about 5% and the peat dust to about 10%, whereupon the biomass is milled to a dust particle size smaller than 500 whereby at least 50% of the particles are smaller than 100 μm.

14. The method of claim 2, characterized in that the wood-based biomass to be milled into wood dust is milled after drying either as such, whereby mixture ratio in the range of 0-30% wood dust and about 100-70% peat dust, or alternatively after torrefaction, whereby mixture ratio is 50-90% wood dust and 10-50% peat dust.

15. The method of claim 3, characterized in that the wood-based biomass to be milled into wood dust is milled after drying either as such, whereby mixture ratio in the range of 0-30% wood dust and about 100-70% peat dust, or alternatively after torrefaction, whereby mixture ratio is 50-90% wood dust and 10-50% peat dust.

16. The method of claim 4, characterized in that the wood-based biomass to be milled into wood dust is milled after drying either as such, whereby mixture ratio in the range of 0-30% wood dust and about 100-70% peat dust, or alternatively after torrefaction, whereby mixture ratio is 50-90% wood dust and 10-50% peat dust.

17. The method of claim 2, characterized in that the wood-based biomass is milled, most advantageously using a cutting grinder, in order to give the dust homogeneous qualities as a well-fluidizing dust.

18. The method of claim 3, characterized in that the wood-based biomass is milled, most advantageously using a cutting grinder, in order to give the dust homogeneous qualities as a well-fluidizing dust.

19. The method of claim 4, characterized in that the wood-based biomass is milled, most advantageously using a cutting grinder, in order to give the dust homogeneous qualities as a well-fluidizing dust.

20. The method of claim 5, characterized in that the wood-based biomass is milled, most advantageously using a cutting grinder, in order to give the dust homogeneous qualities as a well-fluidizing dust.
